(19) United States
(12) Patent Application Publication
(10) Pub. No.: US 2025/0384061 A1
(43) Pub. Date: Dec. 18, 2025

(54) DETECTION OF UNACCOUNTED TENANCIES IN A CLOUD ENVIRONMENT

(71) Applicant: Oracle International Corporation, Redwood Shores, CA (US)

(72) Inventors: Peter Martin Hanily, Dublin (IE); Ryan Daniel Schilcher, Seattle, WA (US); Christopher Robert Baker, Nashua, NH (US); Jonathan Philip Taimanglo, Arlington, VA (US)

(73) Assignee: Oracle International Corporation, Redwood Shores, CA (US)

(21) Appl. No.: 18/745,216

(22) Filed: Jun. 17, 2024

(51) Int. Cl. G06F 16/28; G06F 16/2455

(52) U.S. Cl. CPC G06F 16/285; G06F 16/2456

(57) ABSTRACT

A method for detecting an unaccounted tenancy within a cloud environment is disclosed. The method includes storing, within a first database, (i) identifiers of a set of active cloud resources, and (ii) for each active cloud resource, an identifier of a corresponding tenancy; and storing, within a second database, (i) identifiers of a set of tenancies, and (ii) for each tenancy within the set of tenancies, a corresponding tenancy status. Within the second database, each of a first subset of the set of tenancies has an active status, and each of a second subset of the set of tenancies has a terminated status. The method includes querying the first and second databases to identify a first active cloud resource within a first tenancy, such that the first tenancy has a terminated tenancy status; tagging the first tenancy with an unaccounted tag; and undertaking mitigating actions for the unaccounted first tenancy.

### BACKGROUND

A cloud provider provides on-demand, scalable computing resources (e.g., a cloud environment) to its cloud customers. A cloud customer generally desires to run its cloud resources without monitoring, scanning, or other interference by the cloud provider or other cloud customer. Therefore, the cloud provider offers “tenancies” to its cloud customers. A tenancy is an isolated partition within the cloud environment, such that resources in different tenancies are isolated from each other unless explicitly shared. Each tenancy runs a plurality of virtual machine compute instances.

### BRIEF SUMMARY

In some embodiments, a computer-implemented method includes storing, within a first database, (i) identifiers of a set of active cloud resources within a cloud environment, and (ii) for each active cloud resource within the set of active cloud resources, an identifier of a corresponding tenancy of the cloud environment; and storing, within a second database, (i) identifiers of a set of tenancies within the cloud environment, and (ii) for each tenancy within the set of tenancies, a corresponding tenancy status. In an example, within the second database, each of a first subset of the set of tenancies has a status of being active in the cloud environment. In an example, within the second database, each of a second subset of the set of tenancies has a status of being terminated from the cloud environment. The method further includes querying the first database and the second database to identify a first active cloud resource within a first tenancy, such that the first tenancy has a tenancy status of being terminated from the cloud environment; tagging the first tenancy with an unaccounted tag; and responsive at least in part to the first tenancy being tagged with the unaccounted tag, performing one or more of (i) terminating the first tenancy, (ii) terminating one or more active cloud resources within the first tenancy, including terminating the first active cloud resource, or (iii) changing a status of the first tenancy from terminated to active.

In an example, the method further includes periodically or intermittently querying the first database and the second database, to identify whether any active cloud resource of the first database is within a tenancy having a status of being terminated in the second database.

In an example, the first database and the second database are queried using a multiple joins query that joins data of the first database and the second database.

In an example, the status of the first tenancy is changed from terminated to active, and wherein the method further includes adding the first tenancy to an account database that is used to bill customers of one or more active tenancies of the cloud environment.

In an example, the status of the first tenancy is changed from terminated to active, and wherein the method further includes subsequent to changing the status of the first tenancy from terminated to active, determining that one or more critical information of the first tenancy is missing from one or both the first database and the second database; and generating a report that the one or more critical information of the first tenancy is missing.

In an example, the one or more critical information of the first tenancy comprises one or more of (i) billing information associated with the first tenancy, and/or (ii) contact information associated with the first tenancy. In an example, the set of active cloud resources within the cloud environment include one or more of (i) one or more active compute instances, and (ii) one or more active software agents operating within an active compute instance. In an example, the first database lacks a status of each tenancy, whose identifiers are included within the first database.

In an example, the method further includes receiving communication from a second active cloud resource; identifying a second tenancy including the second active cloud resource, responsive at least in part to receiving the communication from the second active cloud resource; determining a status of the second tenancy; determining that the status of the second tenancy is terminated; tagging the second tenancy with the unaccounted tag; and responsive at least in part to the second tenancy being tagged with the unaccounted tag, performing one or more of (i) terminating the second tenancy, (ii) terminating one or more active cloud resources of the second tenancy, including terminating the second active cloud resource, or (iii) changing a status of the second tenancy from terminated to active. In an example, the second tenancy including the second active cloud resource is identified from the first database. In an example, the status of the second tenancy is determined from the second database.

In some embodiments, a non-transitory computer-readable medium including instructions that when executed by one or more processors, cause the one or more processors to perform operations including: receiving communication from an active cloud resource of a cloud environment; identifying a tenancy including the active cloud resource, responsive at least in part to receiving the communication from the active cloud resource; determining that a status of the tenancy is terminated; identifying a plurality of active cloud resources within the tenancy, the plurality of active cloud resources including the active cloud resource from which the communication was received; tagging the tenancy with an unaccounted tag; and responsive at least in part to the tenancy being tagged with the unaccounted tag, performing one or more of (i) terminating the tenancy, (ii) terminating the plurality of active cloud resources, or (iii) changing a status of the tenancy from terminated to active. In an example, the communication is in the form of a service request, a log message, or data.

In an example, the operations further include storing, within a database, (i) identifiers of a set of active cloud resources within the cloud environment, and (ii) for each active cloud resource within the set of active cloud resources, an identifier of a corresponding tenancy of the cloud environment, wherein the tenancy including the active cloud resource is identified from the database. In an example, the operations further include storing, within a database, (i) identifiers of a set of tenancies within the cloud environment, and (ii) for each tenancy within the set of tenancies, a corresponding tenancy status, wherein the status of the tenancy is determined to be terminated from the database.

In some embodiments, a system for managing agents in a cloud environment includes one or more processors; a first storage repository for storing a first database that includes (i) identifiers of a set of active cloud resources within a cloud environment, and (ii) for each active cloud resource within the set of active cloud resources, an identifier of a corresponding tenancy of the cloud environment; and a second storage repository for storing a second database that includes (i) identifiers of a set of tenancies within the cloud environment, and (ii) for each tenancy within the set of tenancies, a corresponding tenancy status. In an example, within the second database, each of a first subset of the set of tenancies has a status of being active in the cloud environment. In an example, within the second database, each of a second subset of the set of tenancies has a status of being terminated from the cloud environment. In an example, the system further includes one or more non-transitory computer-readable media storing instructions, which, when executed by the system, cause the system to perform a set of actions including: querying the first database and the second database to identify a first active cloud resource within a first tenancy, such that the first tenancy has a tenancy status of being terminated from the cloud environment, tagging the first tenancy with an unaccounted tag, and responsive at least in part to the first tenancy being tagged with the unaccounted tag, performing one or more of (i) terminating the first tenancy, (ii) terminating one or more active cloud resources within the first tenancy, including terminating the first active cloud resource, or (iii) changing a status of the first tenancy from terminated to active.

In an example, the set of actions further includes periodically or intermittently querying the first database and the second database, to identify whether any active cloud resource of the first database is within a tenancy having a status of being terminated in the second database. In an example, the first database and the second database are queried using a multiple joins query that joins data of the first database and the second database. In an example, the status of the first tenancy is changed from terminated to active, and wherein the set of actions further includes adding the first tenancy to an account database that is used to bill customers of one or more active tenancies of the cloud environment. In an example, the set of active cloud resources within the cloud environment include one or more of (i) one or more active compute instances, and (ii) one or more active software agents operating within an active compute instance.

The techniques described above and below may be implemented in a number of ways and in a number of contexts. Several example implementations and contexts are provided with reference to the following figures, as described below in more detail. However, the following implementations and contexts are but a few of many.

### BRIEF DESCRIPTION OF THE DRAWINGS

Various embodiments are described hereinafter with reference to the figures. It should be noted that the figures are not drawn to scale and that the elements of similar structures or functions are represented by like reference numerals throughout the figures. It should also be noted that the figures are only intended to facilitate the description of the embodiments. They are not intended as an exhaustive description of the disclosure or as a limitation on the scope of the disclosure.

FIG. 1 illustrates a block diagram of a cloud environment comprising (i) a plurality of tenancies, each of which have a tenancy status of being active, and (ii) one or more tenancies, each of which have a tenancy status of being terminated, but is not terminated and has one or more active cloud resources.

FIG. 2 illustrates a tenancy status database that stores statuses of a plurality of tenancies associated with a cloud environment.

FIG. 3 illustrates a cloud resource database that stores (i) identifiers of a set of active cloud resources within a cloud environment, and (ii) for each active cloud resource within the set of active cloud resources, an identifier of a corresponding tenancy of the cloud environment.

FIG. 4A illustrates a report generated by a reporting service of a service tenancy, in response to a query service identifying one or more active cloud resources that are within corresponding one or more tenancies that have tenancy statuses of being terminated.

FIG. 4B illustrates another report generated by a reporting service of a service tenancy, in response to a query service identifying one or more active cloud resources that are within corresponding one or more tenancies that have tenancy statuses of being terminated.

FIG. 5A is a flow diagram depicting a method for detecting unaccounted tenancies in a cloud environment, and taking mitigating actions.

FIG. 5B is a flow diagram depicting another method for detecting unaccounted tenancies in a cloud environment, and taking mitigating actions.

FIG. 6 depicts a simplified diagram of a distributed system for implementing certain aspects.

FIG. 7 is a simplified block diagram of one or more components of a system environment by which services provided by one or more components of an embodiment system may be offered as cloud services, in accordance with certain aspects.

FIG. 8 illustrates an example computer system that may be used to implement certain aspects.

### DETAILED DESCRIPTION

Maintaining security of a cloud environment involves controlling access to cloud resources based on permissions specified by respective cloud customers. A cloud customer can grant permissions for accessing cloud resources that it rents, but the cloud customer should not be able to grant permissions for accessing cloud resources rented by other customers. A tenancy is a conceptual bucket that holds cloud resources belonging to a particular cloud customer. An administrator of a tenancy has administrative rights to set access policies for cloud resources in the tenancy; an administrator of a tenancy does not have administrative rights to set access policies for cloud resources in another tenancy. A tenancy of a cloud customer is isolated from another tenancy of another cloud customer. A cloud customer is billed for a tenancy rented out to the cloud customer.

A tenancy of a cloud customer includes a plurality of active cloud resources, such as compute instances that are used to host virtual machines. Other example cloud resources are also described below. A tenancy is created when a new cloud customer joins the cloud environment, and a tenancy is terminated or voided when the corresponding cloud customer decides to leave the cloud environment. Thus, tenancies are dynamically created and terminated in the cloud environment, as and when needed.

Each tenancy of a cloud environment has a corresponding tenancy status. The tenancy status for each tenancy is maintained by the cloud provider. A tenancy having an “active” tenancy status (where such a tenancy is also referred to herein as an “active tenancy”) has active cloud resources therewithin, and a cloud customer of such an active tenancy is billed for usage of the cloud resources within the cloud environment. As the name implies, an active tenancy is active in the cloud environment.

A tenancy having a “terminated” tenancy status (where such a tenancy is also referred to herein as a “terminated tenancy”) is supposedly terminated by the cloud environment, and is supposedly no longer being active. A terminated tenancy was active within the cloud environment in the past, and was supposedly terminated by the provider of the cloud environment, and the tenancy status was changed from being active to being terminated. A terminated tenancy is not supposed to have any active cloud resource. In an example, a cloud customer, to whom a terminated tenancy was rented out prior to marked as being terminated, is no longer billed for the tenancy, after the tenancy is marked as being terminated. Thus, no billing is done for tenancies having the terminated status.

A tenancy may be terminated for a variety of reasons, such as based on a termination request by the cloud customer to whom the tenancy was rented out, by the cloud provider due to non-payment of bills for usage of cloud resources, by the cloud provider due to the tenancy violating rules and regulations of the cloud environment, by the cloud provider due to expiration of a lease agreement between the cloud provider and the cloud customer, and/or other appropriate technical or business related reasons. When a tenancy is terminated, active cloud resources of the tenancy are also supposedly terminated, and the tenancy is supposedly retired.

A terminated tenancy, in an example, is actually terminated by the cloud environment. However, in another example, a terminated tenancy may be marked as being terminated (e.g., tenancy status is changed to being terminated), but is not actually terminated. Thus, albeit marked as being terminated, such a tenancy is still somehow active and has one or more active cloud resources running therewithin. Because the tenancy is marked as being terminated, a cloud customer of the tenancy is not billed by the provider of the cloud environment.

Such a tenancy, which has the tenancy status of being terminated, and yet have active cloud resources and is not actually terminated, is referred to herein as an “unaccounted” or a “ghost” tenancy. Thus, an unaccounted tenancy is supposedly terminated and has a tenancy status of being terminated, and yet the tenancy is active and may have one or more active cloud resources therewithin. Such unaccounted tenancies may be formed due to one or more of a variety of reasons, some of which are described below in detail.

In an example, the cloud environment also includes a service tenancy, which may be accessed and controlled by the provider of the cloud environment. The service tenancy is used by the provider of the cloud environment to monitor one or more aspects of operation of the cloud environment. As described below, the service tenancy executes one or more services, which are used to detect unaccounted tenancies in the cloud environment, and take mitigative actions based on such detection of the unaccounted tenancies.

In an example, the service tenancy maintains, updates, and/or accesses (i) a tenancy status database and (ii) a cloud resource database. In an example, the tenancy status database stores statuses of a plurality of tenancies associated with the cloud environment. For example, the tenancy status database stores (i) identifiers of a set of tenancies within the cloud environment, and (ii) for each tenancy within the set of tenancies, a corresponding tenancy status. The tenancy status database stores tenancy statuses of tenancies that were ever created within the cloud environment (or created within the cloud environment within the last 10 years, or last 5 years, or within a given time frame). Within the tenancy status database, each of a first subset of the set of tenancies has a status of being active in the cloud environment, and each of a second subset of the set of tenancies has a status of being terminated in the cloud environment. Note that a first one or more of the tenancies marked as being terminated in the tenancy status database are actually terminated in the cloud environment; while a second one or more of the tenancies marked as being terminated in the tenancy status database are not actually terminated in the cloud environment and are unaccounted tenancies. However, the tenancy status database does not distinguish between tenancies that are actually terminated, versus tenancies that are marked as being terminated but are not actually terminated. Thus, the tenancy status database alone is not sufficient to identify any unaccounted tenancy, because the tenancy status database marks each of the tenancies as being either active or terminated. In an example, the tenancy status database is updated in real or near real time. For example, when a new active tenancy is created, the tenancy is marked as being active in the tenancy status database. When an active tenancy supposedly transitions from active to being terminated, the tenancy status database updates the status of such a tenancy to being terminated. However, for various reasons (at least some of which have been described below), the tenancy status database may update a tenancy status to terminated, whereas the tenancy in reality has not been terminated, resulting in formation of an unaccounted tenancy.

The cloud resource database, on the other hand, stores (i) identifiers of a set of active cloud resources within the cloud environment, and (ii) for each active cloud resource within the set of active cloud resources, an identifier of a corresponding tenancy of the cloud environment. Note that the cloud resource database does not include a status of a tenancy corresponding to a tenancy identifier (e.g., does not indicate whether a tenancy has a status of being active or terminated). Thus, the cloud resource database includes identifiers of active cloud resources of both active tenancies and unaccounted tenancies. Note that the terminated tenancies, which were actually terminated, do not have any active cloud resources, and the cloud resource database does not include identifiers of active cloud resources of such tenancies.

In an example, the tenancy status database and the cloud resource database are jointly queried, to identify zero, one, or more active cloud resources included within a tenancy having a tenancy status of terminated. For example, a query service issues a query that correlates the tenancy status database and the cloud resource database, where the query aims to detect active cloud resources within a tenancy having a corresponding tenancy status of terminated. Hence, the query is to identify running cloud resources (such as running compute instances) in a tenancy that has a terminated status.

If there exists an active cloud resource within a tenancy having a tenancy status of terminated, then the corresponding terminated tenancy is identified as an unaccounted or ghost tenancy, and tagged with an unaccounted tag. This is because the tenancy has a tenancy status of terminated, and yet the tenancy is not actually terminated and has at least one active cloud resource therewithin.

Once a tenancy is identified and tagged as an unaccounted or ghost tenancy, mitigating actions are taken to remedy the situation. For example, such mitigating actions include one or more of (i) terminating any identified unaccounted tenancies, (ii) terminating active cloud resources within the unaccounted tenancies, and/or (iii) changing statuses of the unaccounted tenancies from terminated to active.

In an example, in addition to (or instead of) the query module jointly querying the tenancy status database and the cloud resource database, an unaccounted tenancy may also be detected based on communication received from an active cloud resource of the unaccounted tenancy. For example, a service agent of the service tenancy provides one or more services to one or more active cloud resources of the cloud environment, where examples of such services have been described below. In an example, to provide such services, the service agent communicates with one or more active cloud resources. Once the service agent receives a communication from an active cloud resource, the service agent looks up a status of the corresponding tenancy including the cloud resource (e.g., from the tenancy status database and the cloud resource database). For example, if the service agent receives a communication from an active cloud resource, the service agent identifies a tenancy including the active cloud resource (e.g., from the cloud resource database). The service agent may further determine that a status of the tenancy is terminated (e.g., from the tenancy status database). Because the service agent is receiving a communication from the cloud resource, the cloud resource has to be an active cloud resource. If it is determined that the cloud resource is within a tenancy that has the terminated status, the service agent infers that the tenancy is an unaccounted or ghost tenancy. Once the service agent identifies such an unaccounted tenancy, mitigating actions are taken to remedy the situation, as also described above.

Thus, various examples and embodiments are described herein to identify unaccounted tenancies in a cloud environment. Mitigating actions are taken to either terminate the unaccounted tenancies and/or associated cloud resources therewithin, or change the statuses of each such unaccounted tenancies from being terminated to being active.

### Detection of Unaccounted or Ghost Tenancies, and Corresponding Mitigating Actions

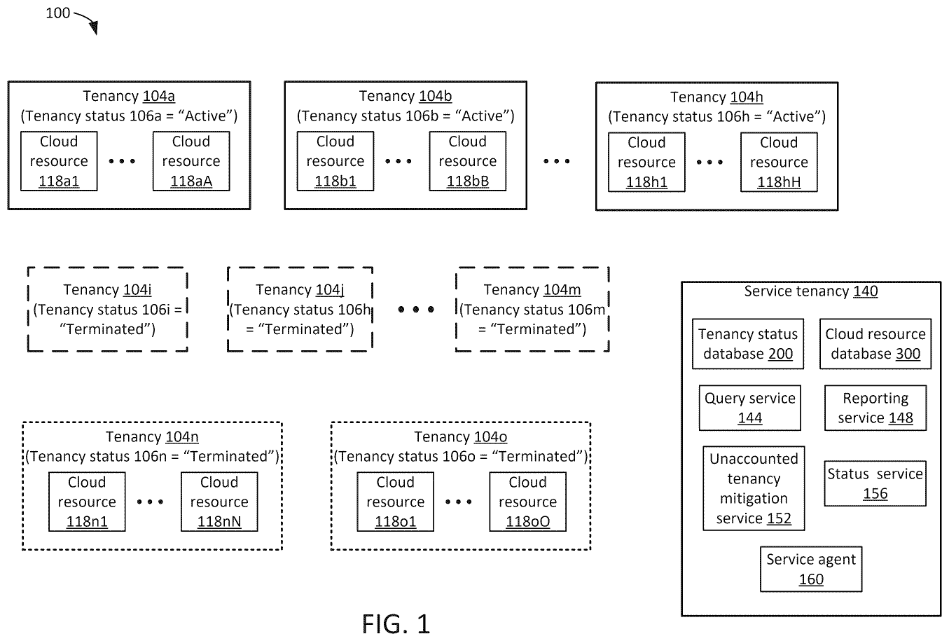

FIG. 1 illustrates a block diagram of a cloud environment 100 comprising (i) a plurality of tenancies 104a, . . . , 104h, each of which have a tenancy status of being active, and (ii) one or more tenancies 104n, 104o, each of which have a tenancy status of being terminated, but is not terminated and has one or more active cloud resources.

As described above, a tenancy is a conceptual bucket that holds cloud resources belonging to a particular cloud customer. A tenancy of a cloud customer is isolated from another tenancy of another cloud customer. A cloud customer is billed for a tenancy rented out to the cloud customer. A tenancy of a cloud customer includes a plurality of active cloud resources, such as compute instances that are used to host virtual machines. Examples of cloud resources include compute instances, networking resources (such as gateways, virtual routers, firewalls, bandwidth and network management software), compartments, software agents operating within computing instances, storage, software applications, and/or any other type(s) of cloud resources generally assigned to tenancies of a cloud environment. A tenancy is created when a new cloud customer joins the cloud environment, and a tenancy is terminated or voided when the corresponding cloud customer decides to leave the cloud environment. Thus, tenancies are dynamically created and terminated in the cloud environment, as and when needed.

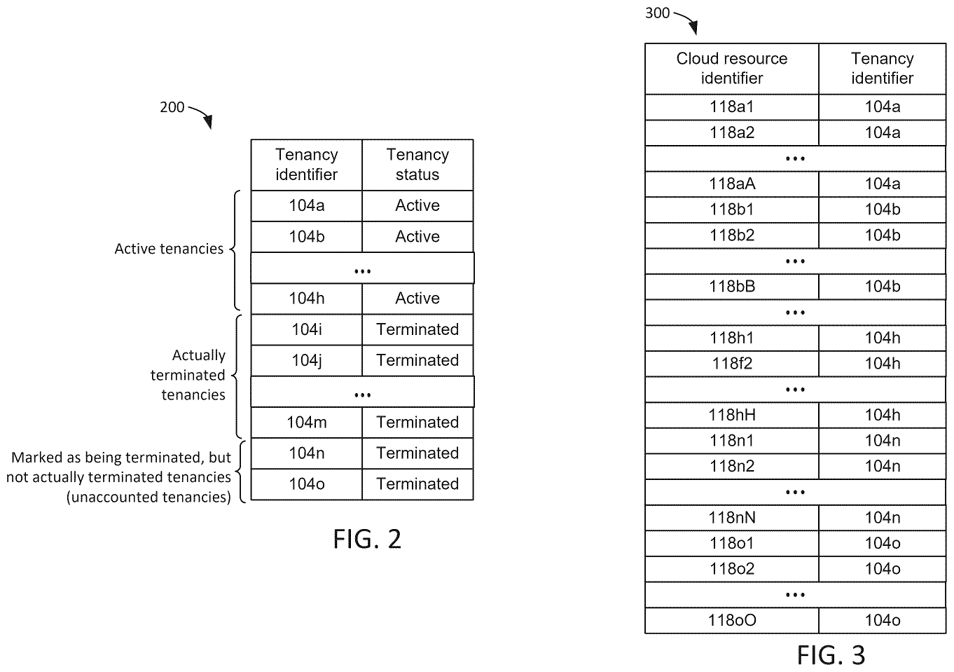

As described above, each tenancy of the cloud environment 100 has a corresponding tenancy status. The tenancy status for each tenancy is maintained by the cloud provider. For example, as described below, a tenancy status database 200 (described further with respect to FIG. 2) stores (i) identifiers of a set of tenancies within the cloud environment 100 and (ii) for each tenancy within the set of tenancies, a corresponding tenancy status.

A tenancy having an “active” tenancy status (where such a tenancy is also referred to herein as an “active tenancy”) has active cloud resources therewithin, and a cloud customer of such an active tenancy is billed for usage of the cloud resources within the cloud environment 100. As the name implies, an active tenancy is active in the cloud environment 100. The database 200 can indicate a tenancy having an active status, based on which the cloud customer of the active tenancy may be billed on a periodic basis (e.g., billed weekly, monthly, or yearly, for example).

The cloud environment 100 of FIG. 1 has a plurality of active tenancies (e.g., tenancies having a tenancy status of being active), such as active tenancies 104a, 104b, . . . , 104h. A tenancy status 106a of the tenancy 104a is active, a tenancy status 106b of the tenancy 104b is active, a tenancy status 106h of the tenancy 104h is active, and so on. The active tenancies 104a, . . . , 104h are illustrated using solid lines in FIG. 1.

Each of the active tenancies 104a, . . . , 104h has a plurality of active cloud resources. For example, active tenancy 104a has cloud resources 118a1, . . . , 118aA, active tenancy 104b has cloud resources 118b1, . . . , 118bB, active tenancy 104h has cloud resources 118h1, . . . , 118hH, and so on. The cloud resources 118a1, . . . , 118hH of the active tenancies 104a, . . . , 104h may be any appropriate cloud resources assigned to the corresponding active tenancies. Examples of cloud resources have been described above.

In an example, the cloud environment 100 included at some point in time in the past a plurality of tenancies 104i, . . . , 104m, 104n, 104o, which currently have corresponding tenancy status of being “terminated”. A tenancy having a “terminated” tenancy status (where such a tenancy is also referred to herein as a “terminated tenancy”) is supposedly terminated by the cloud environment 100, and is supposedly no longer being active. Thus, upon termination of a tenancy, the terminated tenancy is marked as being terminated in the tenancy status database 200. A terminated tenancy is not supposed to have any active cloud resources.

In an example, a cloud customer, to whom a terminated tenancy was rented out prior to marked as being terminated, is no longer billed for the tenancy, after the tenancy is marked as being terminated. Thus, no billing is done for tenancies having the terminated status.

A tenancy may be terminated for a variety of reasons, such as based on a termination request by the cloud customer to whom the tenancy was rented out, by the cloud provider due to non-payment of bills for usage of cloud resources, by the cloud provider due to the tenancy violating rules and regulations of the cloud environment, by the cloud provider due to expiration of a lease agreement between the cloud provider and the cloud customer, and/or other appropriate technical or business related reasons. When a tenancy is terminated, active cloud resources of the tenancy are also supposedly terminated, and the tenancy is supposedly retired.

The plurality of tenancies 104i, . . . , 104m, 104n, 104o having the terminated status includes (i) tenancies 104i, . . . , 104m having the terminated status and which are actually terminated, and (ii) tenancies 104n, 104o having the terminated status but which are not actually terminated.

Thus, each of the tenancies 104i, . . . , 104m has the terminated status and is actually terminated. Accordingly, these tenancies 104i, . . . , 104m are no longer present within the cloud environment 100. Accordingly, these tenancies 104i, . . . , 104m are illustrated using dashed lines, to symbolically represent that these tenancies were previously active in the cloud environment 100, and currently are marked as being terminated and are actually terminated, and hence, not present or active within the cloud environment 100. Because the tenancies 104i, . . . , 104m are actually terminated, these tenancies do not have any assigned active cloud resources, as illustrated in FIG. 1.

In contrast, the tenancies 104n, 104o are marked as being terminated, but are not actually terminated. Thus, the tenancy 104n has a tenancy status 106n of being terminated, and the tenancy 104o has a tenancy status 106o of being terminated, but these tenancies are not actually terminated. For example, each of the tenancies 104n, 104o has one or more active cloud resources, such as cloud resources 118n1, . . . , 118nN within the tenancy 104n, and cloud resources 118o1, . . . , 118oO within the tenancy 104o. Thus, albeit marked as being terminated, the tenancies 104n, 104o are still somehow active and have one or more active cloud resources running therewithin. Because the tenancies 104n, 104o are marked as being terminated, cloud customers of these tenancies are not billed by the provider of the cloud environment 100.

Such tenancies 104n, 104o, which have the tenancy statuses of being terminated, and yet have active cloud resources and are not actually terminated, as referred to herein as “unaccounted” or “ghost” tenancies. Thus, an unaccounted tenancy is supposedly terminated and is marked as being terminated in the database 200, and yet one or more cloud resources of the tenancy are active, and the tenancy is not actually terminated. Although two such unaccounted tenancies 104n, 104o are illustrated within the cloud environment 100, a different number of such unaccounted tenancies (such as one, three, four, or higher) may be present within the cloud environment 100. The unaccounted tenancies are illustrated using dotted lines, to differentiate these tenancies from the active tenancies (illustrated using solid lines) and from terminated tenancies that are actually terminated (illustrated using dashed lines).

Such unaccounted tenancies 104n, 104o may be formed due to one or more of a variety of reasons. In an example, an unaccounted tenancy may be formed due to a system error that is internal to the cloud environment 100, where a technical glitch or inadvertent error within the cloud environment 100 causes formation of the unaccounted tenancy.

In another example, an unaccounted tenancy may be formed due to human error performed by a personal employed by the cloud provider of the cloud environment 100, where the person associated with the provider of the cloud environment incorrectly changed the tenancy status or metadata associated with the tenancy from active to terminated.

In another example, an unaccounted tenancy may be formed due to intentional human act by a personal employed by the cloud provider of the cloud environment 100, where the person associated with the provider of the cloud environment intentionally changed the tenancy status or metadata associated with the tenancy from active to terminated. The intentional human act may be for legitimate reasons (such as for testing and development purposes), or may be malicious (such as a fraudulent action to avoid billing for the tenancy, or for another malicious reason).

In yet an example, an unaccounted tenancy may be formed due to system error that is external to the cloud environment 100, where a technical glitch or inadvertent error from a partner or customer of the cloud environment 100 caused formation of the unaccounted tenancy.

In a further example, an unaccounted tenancy may be formed due to human error performed by a personal outside or not associated with the cloud provider of the cloud environment 100, where the person incorrectly caused the tenancy status or metadata associated with the tenancy being changed from active to terminated.

In another example, an unaccounted tenancy may be formed due to intentional human act by a personal external to the cloud provider of the cloud environment 100, where the person intentionally changed the tenancy status or metadata associated with the tenancy from active to terminated. The intentional human act may be for malicious reasons, such as a fraudulent action to avoid billing for the tenancy, to evade monitoring by the cloud provider, etc.

In an example, the cloud environment 100 also includes a service tenancy 140, which may be accessed and controlled by the provider of the cloud environment 100. The service tenancy 140 is used by the provider of the cloud environment 100 to monitor one or more aspects of operation of the cloud environment 100.

The service tenancy 140 stores, or otherwise has access to one or more repositories storing a tenancy status database 200 (also referred to herein as database 200) and a cloud resource database 300 (also referred to herein as database 300). The one or more repositories storing these databases 200 and 300 may be external to, or internal to the service tenancy 140.

The service tenancy 140 also implements a query service 144 for querying the databases 200 and 300. The service tenancy 140 also implements a reporting service 148 for generating reports identifying zero, one, or more unaccounted tenancies. The service tenancy 140 also implements an unaccounted tenancy mitigation service 152 that facilitates in termination of an unaccounted tenancy and/or active cloud resources within an unaccounted tenancy, and/or facilitates in changing a status of an unaccounted tenancy from terminated to active. The service tenancy 140 also implements a status service 156 that updates status of various tenancies within the database 200. The service tenancy 140 also implements a service agent 160 that provides one or more services to one or more active cloud resources of the cloud environment 100. Each of these services is described below in detail.

FIG. 2 illustrates a tenancy status database 200 that stores statuses of a plurality of tenancies associated with the cloud environment 100. As illustrates in FIG. 1, the database 200 stores (i) identifiers of a set of tenancies 104 within the cloud environment 100, and (ii) for each tenancy within the set of tenancies, a corresponding tenancy status. The database 200 stores tenancy statuses of tenancies that were ever created within the cloud environment 100 (or created within the cloud environment 100 within the last 10 years, or last 5 years, or within a given time frame).

Note that simple labels (such as 104a, 104b, etc.) are used as identifiers of various tenancies in FIG. 2. However, in practical implementation, the tenancy identifiers may be in appropriate format, such as in a binary or hexadecimal format.

Similarly, the tenancy statuses in FIG. 2 are identified as being active or terminated. However, in practical implementation, the tenancy statuses may be represented using one or more bits, such as “0” implying a status of being active and “1” implying a status of being “terminated,” for example.

As illustrated in FIG. 2, within the database 200, each of a first subset of the set of tenancies has a status of being active in the cloud environment 100. For example, tenancies 104a, . . . , 104h are identified as being active in the cloud environment 100, as also illustrated in FIG. 1.

As illustrated in FIG. 2, within the database 200, each of a second subset of the set of tenancies has a status of being terminated in the cloud environment 100. For example, tenancies 104i, . . . , 104m, 104n, 104o are identified as being terminated in the cloud environment 100, as also illustrated in FIG. 1.

Note that a first one or more of the tenancies marked as being terminated in the database 200 (such as tenancies 104i, . . . , 104m) are actually terminated in the cloud environment 100; while a second one or more of the tenancies marked as being terminated in the database 200 (such as tenancies 104n, 104o) are not terminated in the cloud environment 100 and are unaccounted tenancies. However, the database 200 doesn't distinguish between tenancies that are actually terminated, versus tenancies that are marked as being terminated but are not actually terminated. Thus, database 200 alone is not sufficient to identify any unaccounted tenancy, because the database 200 marks each of the tenancies 104i, . . . , 104m, 104n, 104o as being terminated.

In an example, the status service 156 of the service tenancy 140 maintains the database 200, and updates the statuses of various tenancies in real or near real time. For example, when a new active tenancy is created, the status service 156 updates the status of such a tenancy to being active. When an active tenancy transitions to being terminated, the status service 156 updates the status of such a tenancy to being terminated. However, for various reasons (at least some of which have been described above), the status service 156 may update a tenancy status to terminated, whereas the tenancy in reality has not been terminated, resulting in the unaccounted tenancies described above.

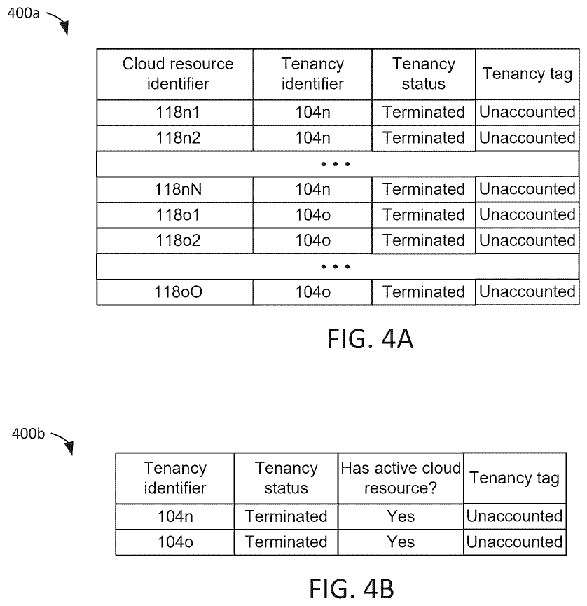

FIG. 3 illustrates a cloud resource database 300 that stores (i) identifiers of a set of active cloud resources 118a1, . . . , 118oO within a cloud environment 100, and (ii) for each active cloud resource within the set of active cloud resources, an identifier of a corresponding tenancy of the cloud environment 100. Note that the database 300 does not include a status of a tenancy corresponding to a tenancy identifier (e.g., does not indicate whether a tenancy has a status of being active or terminated).

As illustrated in FIG. 3, the database 300 stores identifiers of active cloud resources 118a1, . . . , 118aA of tenancy 104a, active cloud resources 118b1, . . . , 118bB of tenancy 104b, active cloud resources 118h1, . . . , 118hH of tenancy 104h. Thus, the database 300 stores identifiers of active cloud resources of the active tenancies 104a, . . . , 104h.

Note that the terminated tenancies 104i, . . . , 104m, which were actually terminated, do not have any active cloud resources, as the cloud resources of these tenancies were terminated with the termination of these tenancies. Accordingly, cloud resources of terminated tenancies 104i, . . . , 104m are not identified in the database 300.

However, each of the unaccounted tenancies 104n, 104o, which were marked as being terminated but not actually terminated, has one or more active cloud resources. For example, the database 300 identifies active cloud resources 118n1, . . . , 118nN of the tenancy 104n, and also identifies active cloud resources 118o1, . . . , 118oO of the tenancy 104o. Note that although the tenancies 104n, 104o were marked as being terminated in the database 200, the termination status of these tenancies is not evident solely from the database 300.

Thus, the database 200 stores status of a plurality of tenancies, including tenancies that have status of being active, and tenancies that have status of being terminated. On the other hand, the database 300 stores identifiers of active cloud resources of active tenancies, as well as identifiers of active cloud resources of unaccounted tenancies.

In an example, the query service 144 queries the databases 200 and 300, to identify zero, one, or more active cloud resources included within a tenancy having a tenancy status of terminated. Thus, the query service 144 issues a query that correlates the two databases 200 and 300, where the query aims to detect active cloud resources within a tenancy having a corresponding tenancy status of terminated. Hence, the query is to identify running cloud resources (such as running compute instances) in a tenancy from the database 300, where the tenancy has a terminated status listed in the database 200. In an example, the databases 200 and 300 are queried using a multiple joins query that joins data of the two databases 200 and 300. Thus, the query service 144 inspects and correlates data from multiple databases 200, 300, to detect any mismatch or discrepancy between tenancies in use (such as tenancies including active cloud resources) versus tenancies listed as having active status, to identify unaccounted or ghost tenancies if any.

If there exists an active cloud resource within a tenancy having a tenancy status of terminated, then the corresponding terminated tenancy is declared as an unaccounted or ghost tenancy, and tagged with an unaccounted tag. This is because the tenancy has a tenancy status of terminated, and yet the tenancy is not actually terminated and has at least one active cloud resource therewithin.

For example, the query may identify that the active cloud resources 118n1, . . . , 118nN are within a tenancy 104n that has a tenancy status of terminated, and also identify that the active cloud resources 118o1, . . . , 118oO are within a tenancy 104o that has a tenancy status of terminated. Thus, the tenancies 104n and 104o are tagged as being unaccounted.

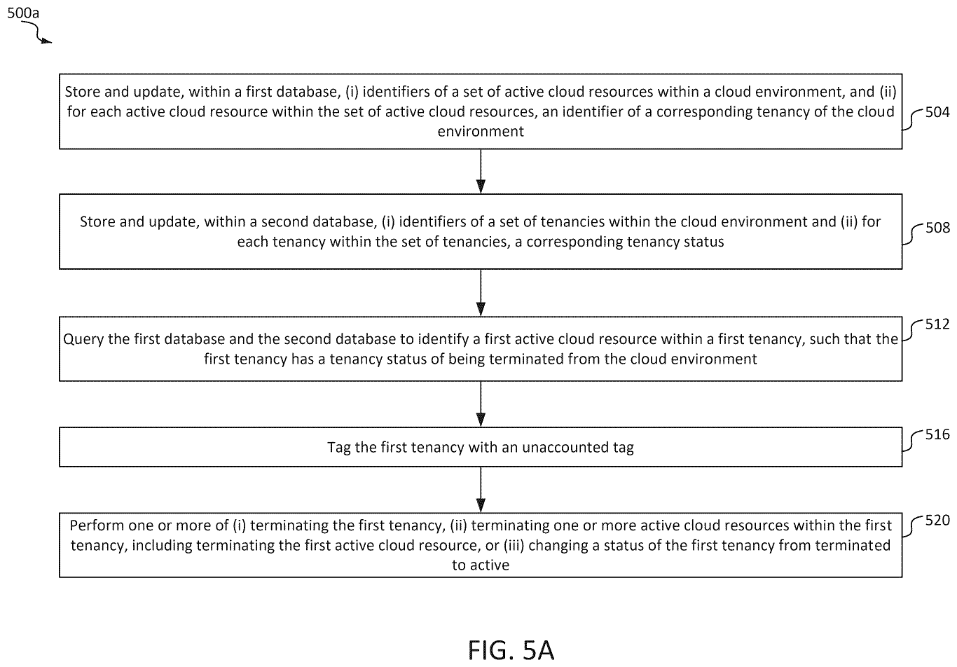

FIG. 4A illustrates a report 400a generated by the reporting service 148 of the service tenancy 140, in response to the query service 144 identifying one or more active cloud resources that are within corresponding one or more tenancies that have tenancy statuses of being terminated. Thus, the report 400a identifies one or more unaccounted tenancies (e.g., terminated tenancies having unaccounted tags). For example, the report 400a identifies a plurality of active cloud resources 118n1, . . . , 118nN within the tenancy 104n that has the tenancy status of terminated, and a plurality of active cloud resources 118o1, . . . , 118oO within the tenancy 104o that has the tenancy status of terminated. Accordingly, each of the tenancies 104n, 104o are tagged with an unaccounted tag.

FIG. 4B illustrates another report 400b generated by the reporting service 148 of the service tenancy 140, in response to the query service 144 identifying one or more active cloud resources that are within corresponding one or more tenancies that have tenancy statuses of being terminated. Note that the report 400a included the lists of active cloud resources within the tenancies tagged with the unaccounted tag, whereas the report 400b does not include the lists of active cloud resources. Rather, the report 400b lists one or more tenancies (such as tenancies 104n, 104o) having active cloud resources and also having the terminated status, and hence, the report 400n tags these tenancies with the unaccounted tag.

In an example, the unaccounted tenancy mitigation service 152 takes mitigation actions to resolve issues associated with unaccounted tenancies. For example, corrective actions are taken based on the reports 400a and/or 400b. Example of such corrective actions include one or more of (i) terminating the unaccounted tenancies, (ii) terminating active cloud resources within the unaccounted tenancies, and/or (iii) changing statuses of the unaccounted tenancies from terminated to active.

Thus, in an example, based on the reports 400a and/or 400b, the unaccounted tenancy mitigation service 152 may terminate the unaccounted tenancies 104n, 104o. Additionally or alternatively, based on the reports 400a and/or 400b, the unaccounted tenancy mitigation service 152 may terminate the active cloud resources 118n1, . . . , 118nN, 118o1, . . . , 118oO, and terminate the unaccounted tenancies 104n, 104o. Additionally or alternatively, based on the reports 400a and/or 400b, the unaccounted tenancy mitigation service 152 may change statuses of the unaccounted tenancies 104n, 104o from terminated to active.

In an example, the above-described querying, reporting, and/or mitigation services for detection, reporting, and mitigating unaccounted tenancies may be repeated periodically within the cloud environment 100, e.g., once every day, or once every week, for example.

In an example, cloud customers of the terminated tenancies are not billed for the terminated tenancies, as these tenancies are supposedly terminated. However, if it is determined that the terminated tenancies actually had active cloud resources that the cloud customers had used, the cloud customers may be billed for the services provided by such active cloud resources.

In an example, if and once the statuses of the unaccounted tenancies 104n, 104o are changed from terminated to active, the cloud customers to whom these tenancies were originally rented out may be billed for usage of cloud resources within the cloud environment 100. For example, such tenancies (whose status changes from terminated to active) may be added to an account or billing database that is used to bill customers of active tenancies of the cloud environment.

In an example, terminated tenancies may have critical associated information deleted or missing from the system. For example, an email address, contact information, and/or billing information (such as credit card or banking information) of a customer of a terminated tenancy (such as a terminated tenancy having an unaccounted tag) may no longer be saved in databases of the provider of the cloud environment. Accordingly, if the status of a terminated tenancy with an unaccounted tag changes from terminated to being active, such critical information (e.g., email address, contact information, and/or billing information) may be missing for such an active tenancy. In an example, the reporting service 148 may detect any missing critical information of such an active tenancy, and generate a corresponding report. Such critical information may be then added back to the databases, e.g., through manual intervention of an employee of the provider of the cloud environment 100.

In an example, the service agent 160 may also facilitate in detection of one or more unaccounted tenancies. For example, as described above, the service tenancy 140 implements the service agent 160 that provides one or more services to one or more active cloud resources of the cloud environment 100. The service agent 160 may provide any appropriate service to the active cloud resources, such as facilitate in updating software of the cloud resources, maintain or store logs or messages generated by one or more cloud resources, provide access to storage services, and/or any other appropriate services that a software agent may provide to cloud resources within a cloud environment.

In an example, to provide such services, the service agent 160 communicates with one or more active cloud resources. For example, the service agent 160 may receive communication from an active cloud resource, where examples of such communication may be a service request from the active cloud resource, a log message from the active cloud resource, data from the active cloud resource, and/or other form of communication from the active cloud resource.

Once the service agent 160 receives a communication from an active cloud resource, the service agent 160 looks up a status of the corresponding tenancy including the cloud resource (e.g., from the databases 200 and 300). For example, if the service agent 160 receives a communication from an active cloud resource 118n1, the service agent 160 determines that the active cloud resource 104n1 is within the tenancy 104n (e.g., from the database 300). The service agent 160 further determines that a status of the tenancy 104n is terminated (e.g., from the database 200).

Because the service agent 160 is receiving a service request from the cloud resource 104n1, the cloud resource 104n1 has to be an active cloud resource. If it is determined that the cloud resource 104n1 is within a tenancy 104n that has the terminated status, the service agent 160 determines that the tenancy 104n is an unaccounted or ghost tenancy.

In an example, the service agent 160 looks up the tenancy status information each time the service agent 160 receives a service request from an active cloud resource. In another example, if the service agent 160 receives multiple communication from an active cloud resource, the service agent 160 may look up the tenancy status information after a threshold number of communications (e.g., for every 100^{th} or 150^{th} communication received from the active cloud resource 118a1, the service agent 160 may look up the corresponding tenancy status information). In another example, if the service agent 160 service multiple communications from an active cloud resource, the service agent 160 may look up the tenancy status information after every threshold period of time (e.g., each day at least once the service agent 160 may look up the corresponding tenancy status for a specific active cloud resource).

If the service agent 160 determines a tenancy is an unaccounted tenancy, the service agent 160 may generate a report that is similar to one of the reports 400a, 400b. Subsequently, the unaccounted tenancy mitigation service 152 may mitigate or resolve the issue with the unaccounted tenancy, as described above in further detail.

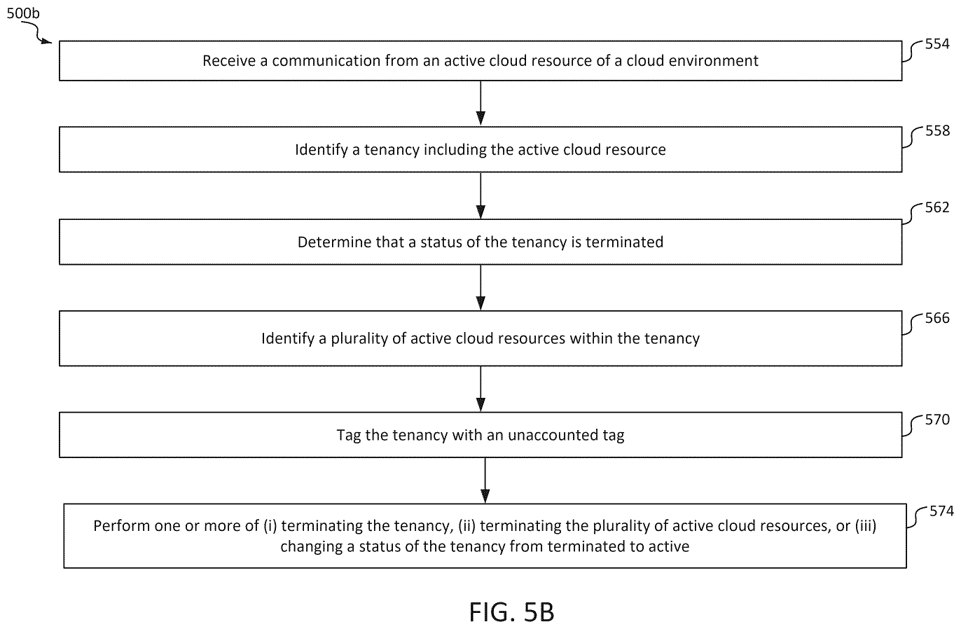

FIG. 5A is a flow diagram depicting a method 500a for detecting unaccounted tenancies in a cloud environment, and taking mitigating actions. At 504, within a first database, the following information is stored and updated at periodic or aperiodic intervals: (i) identifiers of a set of active cloud resources within a cloud environment, and (ii) for each active cloud resource within the set of active cloud resources, an identifier of a corresponding tenancy of the cloud environment. For example, database 300 stores identifiers 118a1, . . . , 118o of corresponding active cloud resources; and also stores, for each such active cloud resource, an identifier of a corresponding tenancy of the cloud environment 100. The first database may be generated and maintained by a provider of the cloud environment 100, such as using one or more services offered by the service tenancy 140.

The method 500a proceeds from 504 to 508. At 508, within a second database, the following information is stored and updated at periodic or aperiodic intervals: (i) identifiers of a set of tenancies within the cloud environment, and (ii) for each tenancy within the set of tenancies, a corresponding tenancy status. For example, database 200 stores identifiers of a set of tenancies 104a, . . . , 104o within the cloud environment 100 (e.g., tenancies that were ever created within the cloud environment 100, or created within the cloud environment 100 within a past threshold time frame such as in last 10 years, or 15 years, for example), and (ii) for each tenancy within the set of tenancies, a corresponding tenancy status. In an example, within the second database, each of a first subset of the set of tenancies has a status of being active in the cloud environment, such as tenancies 104a, . . . , 104h. In an example, within the second database, each of a second subset of the set of tenancies has a status of being terminated from the cloud environment, such as tenancies 104i, . . . , 104o.

Note that the processes 504 and 508 need not be executed sequentially, and may be performed at least in part in parallel, or in any other order. In an example, the information stored in the first and second databases at processes 504 and 508, respectively, may be updated as and when new information is available (e.g., when a new tenancy is formed, a tenancy transitions from active to terminated, a new cloud resource is added to a tenancy, a cloud resource is terminated or removed from a tenancy, and/or the like).

The method 500a proceeds from 508 to 512. At 512, a query service (such as the query service 144 of FIG. 1) queries the first database and the second database to identify a first active cloud resource within a first tenancy, such that the first tenancy has a tenancy status of being terminated from the cloud environment. In an example, the first and second databases are queried using a multiple joins query that joins data of the two databases. For example, the query identifies the active cloud resource 118n1 within the tenancy 104n in the database 300, such that the tenancy 104n has a tenancy status of being terminated from the cloud environment in the database 200.

The method 500a proceeds from 512 to 516. At 516, the first tenancy is tagged with an unaccounted tag, e.g., by the reporting service 148 of FIG. 1.

The method 500a proceeds from 516 to 520. At 520, mitigation actions are performed, e.g., by the unaccounted tenancy mitigation service 152. For example, one or more of the following are performed: (i) terminating the first tenancy, (ii) terminating one or more active cloud resources within the first tenancy, including terminating the first active cloud resource, or (iii) changing a status of the first tenancy from terminated to active.

FIG. 5B is a flow diagram depicting another method 500b for detecting unaccounted tenancies in a cloud environment, and taking mitigating actions. At 554, a communication is received from an active cloud resource of a cloud environment, e.g., by the service agent 160 of FIG. 1. Examples of such communication have been described above.

At 558, a tenancy including the active cloud resource is identified, e.g., using the database 300. For example, if the communication is received from the cloud resource 118n1, then the tenancy 104n including the cloud resource 118n1 is identified (e.g., by the service agent 160) using the database 300.

At 562, a determination is made that a status of the tenancy is terminated. For example, the service agent 160 uses the database 200 to determine that the tenancy 104n has a corresponding terminated status.

At 566, a plurality of active cloud resources that are within the tenancy is identified, e.g., by the service agent 160. The plurality of active cloud resources includes the active cloud resource from which the communication was received. In an example, the service agent 160 uses the database 300 to identify cloud resources 118n1, . . . , 118nN that are within the tenancy 104n.

At 570, the tenancy is tagged with an unaccounted tag, e.g., by the reporting service 148 of FIG. 1.

At 574, mitigation actions are performed, e.g., by the unaccounted tenancy mitigation service 152. For example, one or more of the following are performed: (i) terminating the tenancy, (ii) terminating the plurality of active cloud resources within the tenancy, or (iii) changing a status of the tenancy from terminated to active.

### Computer System Architecture

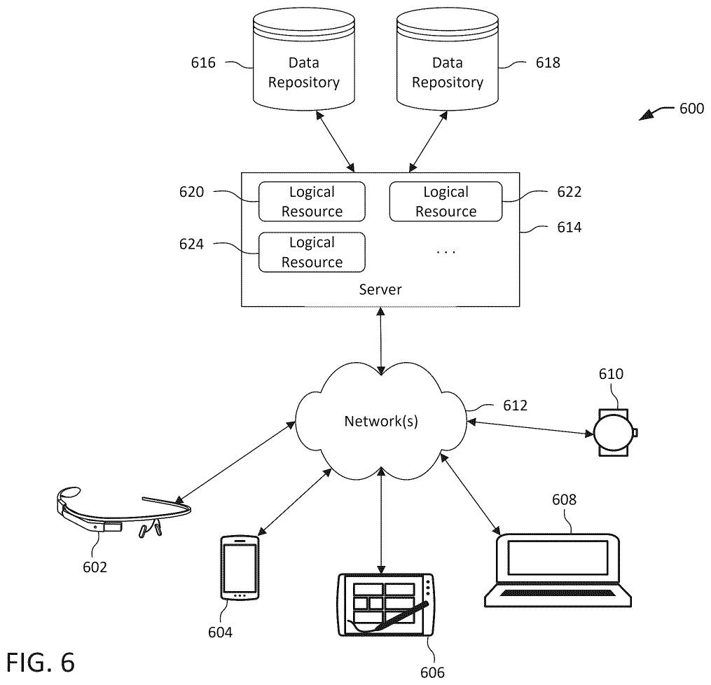

FIG. 6 depicts a simplified diagram of a distributed system 600 for implementing an embodiment. In the illustrated embodiment, distributed system 600 includes one or more client computing devices 602, 604, 606, 608, and/or 610 coupled to a server 614 via one or more communication networks 612. Clients computing devices 602, 604, 606, 608, and/or 610 may be configured to execute one or more applications.

In various aspects, server 614 may be adapted to run one or more services or software applications that enable techniques for detecting unaccounted tenancies, and/or taking mitigating actions to terminate the unaccounted tenancies and/or the cloud resources therewithin, or to change a status of the unaccounted tenancies from terminated to active. In certain aspects, server 614 may also provide other services or software applications that can include non-virtual and virtual environments. In some aspects, these services may be offered as web-based or cloud services, such as under a Software as a Service (SaaS) model to the users of client computing devices 602, 604, 606, 608, and/or 610. Users operating client computing devices 602, 604, 606, 608, and/or 610 may in turn utilize one or more client applications to interact with server 614 to utilize the services provided by these components.

In the configuration depicted in FIG. 6, server 614 may include one or more components 620, 622 and 624 that implement the functions performed by server 614. These components may include software components that may be executed by one or more processors, hardware components, or combinations thereof. It should be appreciated that various different system configurations are possible, which may be different from distributed system 600. The embodiment shown in FIG. 6 is thus one example of a distributed system for implementing an embodiment system and is not intended to be limiting.

Users may use client computing devices 602, 604, 606, 608, and/or 610 for techniques for accessing one or more cloud applications, cloud resources, and/or tenancies, in accordance with the teachings of this disclosure. A client device may provide an interface that enables a user of the client device to interact with the client device. The client device may also output information to the user via this interface. Although FIG. 6 depicts only five client computing devices, any number of client computing devices may be supported.

The client devices may include various types of computing systems such as smart phones or other portable handheld devices, general purpose computers such as personal computers and laptops, workstation computers, personal assistant devices, smart watches, smart glasses, or other wearable devices, equipment firmware, gaming systems, thin clients, various messaging devices, sensors or other sensing devices, and the like. These computing devices may run various types and versions of software applications and operating systems (e.g., Microsoft Windows®, Apple Macintosh®, UNIX® or UNIX-like operating systems, Linux® or Linux-like operating systems such as Oracle® Linux and Google Chrome® OS) including various mobile operating systems (e.g., Microsoft Windows Mobile®, iOS®, Windows Phone®, Android®, HarmonyOS®, Tizen®, KaiOS®, Sailfish® OS, Ubuntu® Touch, CalyxOS®). Portable handheld devices may include cellular phones, smartphones, (e.g., an iPhone®), tablets (e.g., iPad®), and the like. Virtual personal assistants such as Amazon® Alexa®, Google® Assistant, Microsoft® Cortana®, Apple® Siri®, and others may be implemented on devices with a microphone and/or camera to receive user or environmental inputs, as well as a speaker and/or display to respond to the inputs. Wearable devices may include Apple® Watch, Samsung Galaxy® Watch, Meta Quest®, Ray-Ban® Meta® smart glasses, Snap® Spectacles, and other devices. Gaming systems may include various handheld gaming devices, Internet-enabled gaming devices (e.g., a Microsoft Xbox® gaming console with or without a Kinect® gesture input device, Sony PlayStation® system, Nintendo Switch®, and other devices), and the like. The client devices may be capable of executing various different applications such as various Internet-related apps, communication applications (e.g., e-mail applications, short message service (SMS) applications) and may use various communication protocols.

Network(s) 612 may be any type of network familiar to those skilled in the art that can support data communications using any of a variety of available protocols, including without limitation TCP/IP (transmission control protocol/Internet protocol), SNA (systems network architecture), IPX (Internet packet exchange), AppleTalk®, and the like. Merely by way of example, network(s) 612 can be a local area network (LAN), networks based on Ethernet, Token-Ring, a wide-area network (WAN), the Internet, a virtual network, a virtual private network (VPN), an intranet, an extranet, a public switched telephone network (PSTN), an infra-red network, a wireless network (e.g., a network operating under any of the Institute of Electrical and Electronics (IEEE) 1002.11 suite of protocols, Bluetooth®, and/or any other wireless protocol), and/or any combination of these and/or other networks.

Server 614 may be composed of one or more general purpose computers, specialized server computers (including, by way of example, PC (personal computer) servers, UNIX® servers, LINIX® servers, mid-range servers, mainframe computers, rack-mounted servers, etc.), server farms, server clusters, a Real Application Cluster (RAC), database servers, or any other appropriate arrangement and/or combination. Server 614 can include one or more virtual machines running virtual operating systems, or other computing architectures involving virtualization such as one or more flexible pools of logical storage devices that can be virtualized to maintain virtual storage devices for the server. In various aspects, server 614 may be adapted to run one or more services or software applications that provide the functionality described in the foregoing disclosure.

The computing systems in server 614 may run one or more operating systems including any of those discussed above, as well as any commercially available server operating system. Server 614 may also run any of a variety of additional server applications and/or mid-tier applications, including HTTP (hypertext transport protocol) servers, FTP (file transfer protocol) servers, CGI (common gateway interface) servers, JAVA® servers, database servers, and the like. Exemplary database servers include without limitation those commercially available from Oracle®, Microsoft®, SAP®, Amazon®, Sybase®, IBM® (International Business Machines), and the like.

In some implementations, server 614 may include one or more applications to analyze and consolidate data feeds and/or event updates received from users of client computing devices 602, 604, 606, 608, and/or 610. As an example, data feeds and/or event updates may include, but are not limited to, blog feeds, Threads® feeds, Twitter® feeds, Facebook® updates or real-time updates received from one or more third party information sources and continuous data streams, which may include real-time events related to sensor data applications, financial tickers, network performance measuring tools (e.g., network monitoring and traffic management applications), clickstream analysis tools, automobile traffic monitoring, and the like. Server 614 may also include one or more applications to display the data feeds and/or real-time events via one or more display devices of client computing devices 602, 604, 606, 608, and/or 610.

Distributed system 600 may also include one or more data repositories 616, 618. These data repositories may be used to store data and other information in certain aspects. For example, one or more of the data repositories 616, 618 may be used to store databases 200, 300 described above. Data repositories 616, 618 may reside in a variety of locations. For example, a data repository used by server 614 may be local to server 614 or may be remote from server 614 and in communication with server 614 via a network-based or dedicated connection. Data repositories 616, 618 may be of different types. In certain aspects, a data repository used by server 614 may be a database, for example, a relational database, a container database, an Exadata® storage device, or other data storage and retrieval tool such as databases provided by Oracle Corporation® and other vendors. One or more of these databases may be adapted to enable storage, update, and retrieval of data to and from the database in response to structured query language (SQL)-formatted commands.

In certain aspects, one or more of data repositories 616, 618 may also be used by applications to store application data. The data repositories used by applications may be of different types such as, for example, a key-value store repository, an object store repository, or a general storage repository supported by a file system.

In one embodiment, server 614 is part of a cloud-based system environment in which various services may be offered as cloud services, for a single tenant or for multiple tenants where data, requests, and other information specific to the tenant are kept private from each tenant. In the cloud-based system environment, multiple servers may communicate with each other to perform the work requested by client devices from the same or multiple tenants. The servers communicate on a cloud-side network that is not accessible to the client devices in order to perform the requested services and keep tenant data confidential from other tenants.

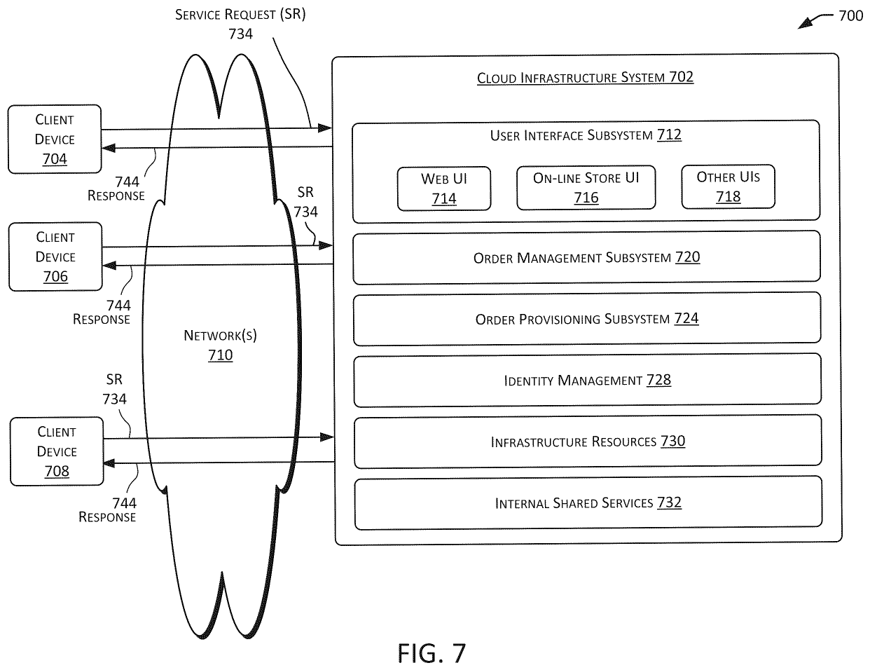

FIG. 7 is a simplified block diagram of a cloud-based system environment in which techniques are employed for detecting unaccounted tenancies, and/or taking mitigating actions to terminate the unaccounted tenancies and/or the cloud resources therewithin, or to change a status of the unaccounted tenancies from terminated to active.

In the embodiment depicted in FIG. 7, cloud infrastructure system 702 may provide one or more cloud services that may be requested by users using one or more client computing devices 704, 706, and 708. Cloud infrastructure system 702 may comprise one or more computers and/or servers that may include those described above for server 612. The computers in cloud infrastructure system 702 may be organized as general purpose computers, specialized server computers, server farms, server clusters, or any other appropriate arrangement and/or combination.

Network(s) 710 may facilitate communication and exchange of data between clients 704, 706, and 708 and cloud infrastructure system 702. Network(s) 710 may include one or more networks. The networks may be of the same or different types. Network(s) 710 may support one or more communication protocols, including wired and/or wireless protocols, for facilitating the communications.

The embodiment depicted in FIG. 7 is only one example of a cloud infrastructure system and is not intended to be limiting. It should be appreciated that, in some other aspects, cloud infrastructure system 702 may have more or fewer components than those depicted in FIG. 7, may combine two or more components, or may have a different configuration or arrangement of components. For example, although FIG. 7 depicts three client computing devices, any number of client computing devices may be supported in alternative aspects.

The term cloud service is generally used to refer to a service that is made available to users on demand and via a communication network such as the Internet by systems (e.g., cloud infrastructure system 702) of a service provider. Typically, in a public cloud environment, servers and systems that make up the cloud service provider's system are different from the cloud customer's (“tenant's”) own on-premise servers and systems. The cloud service provider's systems are managed by the cloud service provider. Tenants can thus avail themselves of cloud services provided by a cloud service provider without having to purchase separate licenses, support, or hardware and software resources for the services. For example, a cloud service provider's system may host an application, and a user may, via a network 710 (e.g., the Internet), on demand, order and use the application without the user having to buy infrastructure resources for executing the application. Cloud services are designed to provide easy, scalable access to applications, resources, and services. Several providers offer cloud services. For example, several cloud services are offered by Oracle Corporation®, such as database services, middleware services, application services, and others.

In certain aspects, cloud infrastructure system 702 may provide one or more cloud services using different models such as under a Software as a Service (SaaS) model, a Platform as a Service (PaaS) model, an Infrastructure as a Service (IaaS) model, a Data as a Service (DaaS) model, and others, including hybrid service models. Cloud infrastructure system 702 may include a suite of databases, middleware, applications, and/or other resources that enable provision of the various cloud services.

A SaaS model enables an application or software to be delivered to a tenant's client device over a communication network like the Internet, as a service, without the tenant having to buy the hardware or software for the underlying application. For example, a SaaS model may be used to provide tenants access to on-demand applications that are hosted by cloud infrastructure system 702. Examples of SaaS services provided by Oracle Corporation® include, without limitation, various services for human resources/capital management, client relationship management (CRM), enterprise resource planning (ERP), supply chain management (SCM), enterprise performance management (EPM), analytics services, social applications, and others.

An IaaS model is generally used to provide infrastructure resources (e.g., servers, storage, hardware, and networking resources) to a tenant as a cloud service to provide elastic compute and storage capabilities. Various IaaS services are provided by Oracle Corporation®.

A PaaS model is generally used to provide, as a service, platform and environment resources that enable tenants to develop, run, and manage applications and services without the tenant having to procure, build, or maintain such resources. Examples of PaaS services provided by Oracle Corporation® include, without limitation, Oracle Database Cloud Service (DBCS), Oracle Java Cloud Service (JCS), data management cloud service, various application development solutions services, and others.

A DaaS model is generally used to provide data as a service. Datasets may searched, combined, summarized, and downloaded or placed into use between applications. For example, user profile data may be updated by one application and provided to another application. As another example, summaries of user profile information generated based on a dataset may be used to enrich another dataset.

Cloud services are generally provided on an on-demand self-service basis, subscription-based, elastically scalable, reliable, highly available, and secure manner. For example, a tenant, via a subscription order, may order one or more services provided by cloud infrastructure system 702. Cloud infrastructure system 702 then performs processing to provide the services requested in the tenant's subscription order. Cloud infrastructure system 702 may be configured to provide one or even multiple cloud services.

Cloud infrastructure system 702 may provide the cloud services via different deployment models. In a public cloud model, cloud infrastructure system 702 may be owned by a third party cloud services provider and the cloud services are offered to any general public tenant, where the tenant can be an individual or an enterprise. In certain other aspects, under a private cloud model, cloud infrastructure system 702 may be operated within an organization (e.g., within an enterprise organization) and services provided to clients that are within the organization. For example, the clients may be various departments or employees or other individuals of departments of an enterprise such as the Human Resources department, the Payroll department, etc., or other individuals of the enterprise. In certain other aspects, under a community cloud model, the cloud infrastructure system 702 and the services provided may be shared by several organizations in a related community. Various other models such as hybrids of the above mentioned models may also be used.

Client computing devices 704, 706, and 708 may be of different types (such as devices 602, 604, 606, and 608 depicted in FIG. 6) and may be capable of operating one or more client applications. A user may use a client device to interact with cloud infrastructure system 702, such as to request a service provided by cloud infrastructure system 702.

In some aspects, the processing performed by cloud infrastructure system 702 for providing chatbot services may involve big data analysis. This analysis may involve using, analyzing, and manipulating large data sets to detect and visualize various trends, behaviors, relationships, etc. within the data. This analysis may be performed by one or more processors, possibly processing the data in parallel, performing simulations using the data, and the like. For example, big data analysis may be performed by cloud infrastructure system 702 for determining the intent of an utterance. The data used for this analysis may include structured data (e.g., data stored in a database or structured according to a structured model) and/or unstructured data (e.g., data blobs (binary large objects)).

As depicted in the embodiment in FIG. 7, cloud infrastructure system 702 may include infrastructure resources 730 that are utilized for facilitating the provision of various cloud services offered by cloud infrastructure system 702. Infrastructure resources 730 may include, for example, processing resources, storage or memory resources, networking resources, and the like.

In certain aspects, to facilitate efficient provisioning of these resources for supporting the various cloud services provided by cloud infrastructure system 702 for different tenants, the resources may be bundled into sets of resources or resource modules (also referred to as “pods”). Each resource module or pod may comprise a pre-integrated and optimized combination of resources of one or more types. In certain aspects, different pods may be pre-provisioned for different types of cloud services. For example, a first set of pods may be provisioned for a database service, a second set of pods, which may include a different combination of resources than a pod in the first set of pods, may be provisioned for Java service, and the like. For some services, the resources allocated for provisioning the services may be shared between the services.

Cloud infrastructure system 702 may itself internally use services 732 that are shared by different components of cloud infrastructure system 702 and which facilitate the provisioning of services by cloud infrastructure system 702. These internal shared services may include, without limitation, a security and identity service, an integration service, an enterprise repository service, an enterprise manager service, a virus scanning and whitelist service, a high availability, backup and recovery service, service for enabling cloud support, an email service, a notification service, a file transfer service, and the like.

Cloud infrastructure system 702 may comprise multiple subsystems. These subsystems may be implemented in software, or hardware, or combinations thereof. As depicted in FIG. 7, the subsystems may include a user interface subsystem 712 that enables users of cloud infrastructure system 702 to interact with cloud infrastructure system 702. User interface subsystem 712 may include various different interfaces such as a web interface 714, an online store interface 716 where cloud services provided by cloud infrastructure system 702 are advertised and are purchasable by a consumer, and other interfaces 718. For example, a tenant may, using a client device, request (service request 734) one or more services provided by cloud infrastructure system 702 using one or more of interfaces 714, 716, and 718. For example, a tenant may access the online store, browse cloud services offered by cloud infrastructure system 702, and place a subscription order for one or more services offered by cloud infrastructure system 702 that the tenant wishes to subscribe to. The service request may include information identifying the tenant and one or more services that the tenant desires to subscribe to.

In certain aspects, such as the embodiment depicted in FIG. 7, cloud infrastructure system 702 may comprise an order management subsystem (OMS) 720 that is configured to process the new order. As part of this processing, OMS 720 may be configured to: create an account for the tenant, if not done already; receive billing and/or accounting information from the tenant that is to be used for billing the tenant for providing the requested service to the tenant; verify the tenant information; upon verification, book the order for the tenant; and orchestrate various workflows to prepare the order for provisioning.

Once properly validated, OMS 720 may then invoke the order provisioning subsystem (OPS) 724 that is configured to provision resources for the order including processing, memory, and networking resources. The provisioning may include allocating resources for the order and configuring the resources to facilitate the service requested by the tenant order. The manner in which resources are provisioned for an order and the type of the provisioned resources may depend upon the type of cloud service that has been ordered by the tenant. For example, according to one workflow, OPS 724 may be configured to determine the particular cloud service being requested and identify a number of pods that may have been pre-configured for that particular cloud service. The number of pods that are allocated for an order may depend upon the size/amount/level/scope of the requested service. For example, the number of pods to be allocated may be determined based upon the number of users to be supported by the service, the duration of time for which the service is being requested, and the like. The allocated pods may then be customized for the particular requesting tenant for providing the requested service.

Cloud infrastructure system 702 may send a response or notification 744 to the requesting tenant to indicate when the requested service is now ready for use. In some instances, information (e.g., a link) may be sent to the tenant that enables the tenant to start using and availing the benefits of the requested services.

Cloud infrastructure system 702 may provide services to multiple tenants. For each tenant, cloud infrastructure system 702 is responsible for managing information related to one or more subscription orders received from the tenant, maintaining tenant data related to the orders, and providing the requested services to the tenant or clients of the tenant. Cloud infrastructure system 702 may also collect usage statistics regarding a tenant's use of subscribed services. For example, statistics may be collected for the amount of storage used, the amount of data transferred, the number of users, and the amount of system up time and system down time, and the like. This usage information may be used to bill the tenant. Billing may be done, for example, on a monthly cycle.

Cloud infrastructure system 702 may provide services to multiple tenants in parallel. Cloud infrastructure system 702 may store information for these tenants, including possibly proprietary information. In certain aspects, cloud infrastructure system 702 comprises an identity management subsystem (IMS) 728 that is configured to manage tenant's information and provide the separation of the managed information such that information related to one tenant is not accessible by another tenant. IMS 728 may be configured to provide various security-related services such as identity services, such as information access management, authentication and authorization services, services for managing tenant identities and roles and related capabilities, and the like.

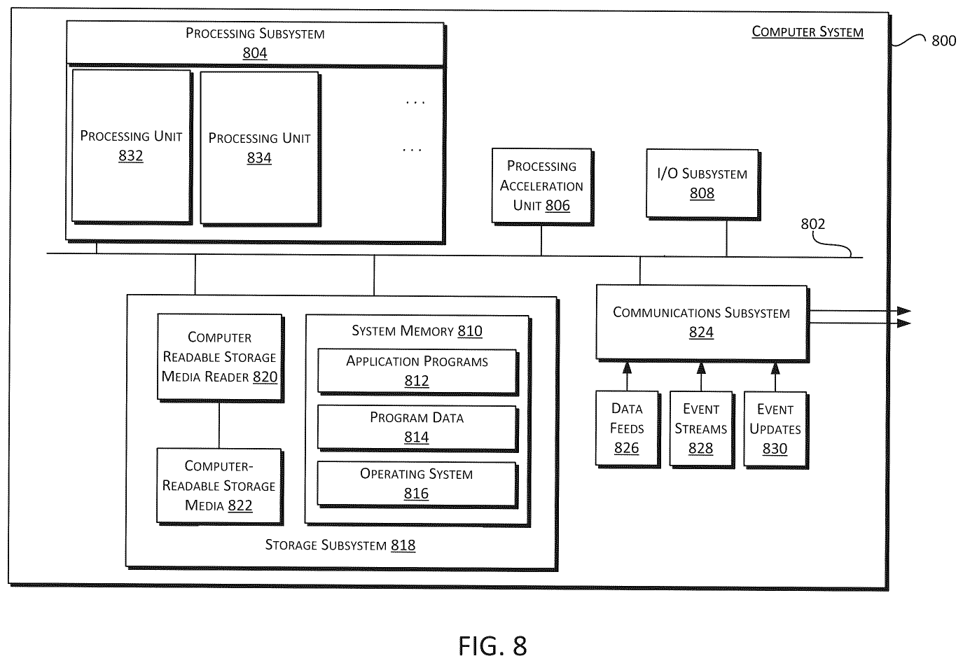

FIG. 8 illustrates an exemplary computer system 800 that may be used to implement certain aspects. As shown in FIG. 8, computer system 800 includes various subsystems including a processing subsystem 804 that communicates with a number of other subsystems via a bus subsystem 802. These other subsystems may include a processing acceleration unit 806, an I/O subsystem 808, a storage subsystem 818, and a communications subsystem 824. Storage subsystem 818 may include non-transitory computer-readable storage media including storage media 822 and a system memory 810.

Bus subsystem 802 provides a mechanism for letting the various components and subsystems of computer system 800 communicate with each other as intended. Although bus subsystem 802 is shown schematically as a single bus, alternative aspects of the bus subsystem may utilize multiple buses. Bus subsystem 802 may be any of several types of bus structures including a memory bus or memory controller, a peripheral bus, a local bus using any of a variety of bus architectures, and the like. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard, and the like.

Processing subsystem 804 controls the operation of computer system 800 and may comprise one or more processors, application specific integrated circuits (ASICs), or field programmable gate arrays (FPGAs). The processors may include be single core or multicore processors. The processing resources of computer system 800 can be organized into one or more processing units 832, 834, etc. A processing unit may include one or more processors, one or more cores from the same or different processors, a combination of cores and processors, or other combinations of cores and processors. In some aspects, processing subsystem 804 can include one or more special purpose co-processors such as graphics processors, digital signal processors (DSPs), or the like. In some aspects, some or all of the processing units of processing subsystem 804 can be implemented using customized circuits, such as application specific integrated circuits (ASICs), or field programmable gate arrays (FPGAs).

In some aspects, the processing units in processing subsystem 804 can execute instructions stored in system memory 810 or on computer readable storage media 822. In various aspects, the processing units can execute a variety of programs or code instructions and can maintain multiple concurrently executing programs or processes. At any given time, some or all of the program code to be executed can be resident in system memory 810 and/or on computer-readable storage media 822 including potentially on one or more storage devices. Through suitable programming, processing subsystem 804 can provide various functionalities described above. In instances where computer system 800 is executing one or more virtual machines, one or more processing units may be allocated to each virtual machine.

In certain aspects, a processing acceleration unit 806 may optionally be provided for performing customized processing or for off-loading some of the processing performed by processing subsystem 804 so as to accelerate the overall processing performed by computer system 800.

I/O subsystem 808 may include devices and mechanisms for inputting information to computer system 800 and/or for outputting information from or via computer system 800. In general, use of the term input device is intended to include all possible types of devices and mechanisms for inputting information to computer system 800. User interface input devices may include, for example, a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may also include motion sensing and/or gesture recognition devices such as the Meta Quest® controller, Microsoft Kinect® motion sensor, the Microsoft Xbox® 360 game controller, or devices that provide an interface for receiving input using gestures and spoken commands. User interface input devices may also include eye gesture recognition devices such as a blink detector that detects eye activity (e.g., “blinking” while taking pictures and/or making a menu selection) from users and transforms the eye gestures as inputs to an input device. Additionally, user interface input devices may include voice recognition sensing devices that enable users to interact with voice recognition systems (e.g., Siri® navigator or Amazon Alexa®) through voice commands.

Other examples of user interface input devices include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, QR code readers, barcode readers, 3D scanners, 3D printers, laser rangefinders, and eye gaze tracking devices. Additionally, user interface input devices may include, for example, medical imaging input devices such as computed tomography, magnetic resonance imaging, position emission tomography, and medical ultrasonography devices. User interface input devices may also include, for example, audio input devices such as MIDI keyboards, digital musical instruments, and the like.

In general, use of the term output device is intended to include all possible types of devices and mechanisms for outputting information from computer system 800 to a user or other computer. User interface output devices may include a display subsystem, indicator lights, or non-visual displays such as audio output devices, etc. The display subsystem may be any device for outputting a digital picture. Example display devices include flat panel display devices such as those using a light emitting diode (LED) display, a liquid crystal display (LCD) or plasma display, a projection device, a touch screen, a desktop or laptop computer monitor, and the like. As another example, wearable display devices such as Meta Quest® or Microsoft HoloLens® may be mounted to the user for displaying information. User interface output devices may include, without limitation, a variety of display devices that visually convey text, graphics, and audio/video information such as monitors, printers, speakers, headphones, automotive navigation systems, plotters, voice output devices, and modems.

Storage subsystem 818 provides a repository or data store for storing information and data that is used by computer system 800. Storage subsystem 818 provides a tangible non-transitory computer-readable storage medium for storing the basic programming and data constructs that provide the functionality of some aspects. Storage subsystem 818 may store software (e.g., programs, code modules, instructions) that when executed by processing subsystem 804 provides the functionality described above. The software may be executed by one or more processing units of processing subsystem 804. Storage subsystem 818 may also provide a repository for storing data used in accordance with the teachings of this disclosure.

Storage subsystem 818 may include one or more non-transitory memory devices, including volatile and non-volatile memory devices. As shown in FIG. 8, storage subsystem 818 includes a system memory 810 and a computer-readable storage media 822. System memory 810 may include a number of memories including a volatile main random access memory (RAM) for storage of instructions and data during program execution and a non-volatile read only memory (ROM) or flash memory in which fixed instructions are stored. In some implementations, a basic input/output system (BIOS), containing the basic routines that help to transfer information between elements within computer system 800, such as during start-up, may typically be stored in the ROM. The RAM typically contains data and/or program modules that are presently being operated and executed by processing subsystem 804. In some implementations, system memory 810 may include multiple different types of memory, such as static random access memory (SRAM), dynamic random access memory (DRAM), and the like.

By way of example, and not limitation, as depicted in FIG. 8, system memory 810 may load application programs 812 that are being executed, which may include various applications such as Web browsers, mid-tier applications, relational database management systems (RDBMS), etc., program data 814, and an operating system 816. By way of example, operating system 816 may include various versions of Microsoft Windows®, Apple Macintosh®, and/or Linux® operating systems, a variety of commercially-available UNIX® or UNIX-like operating systems (including without limitation the variety of GNU/Linux operating systems, the Oracle Linux®, Google Chrome® OS, and the like) and/or mobile operating systems such as iOS, Windows® Phone, Android® OS, and others.

Computer-readable storage media 822 may store programming and data constructs that provide the functionality of some aspects. Computer-readable media 822 may provide storage of computer-readable instructions, data structures, program modules, and other data for computer system 800. Software (programs, code modules, instructions) that, when executed by processing subsystem 804 provides the functionality described above, may be stored in storage subsystem 818. By way of example, computer-readable storage media 822 may include non-volatile memory such as a hard disk drive, a magnetic disk drive, an optical disk drive such as a CD ROM, digital video disc (DVD), a Blu-Ray® disk, or other optical media. Computer-readable storage media 822 may include, but is not limited to, Zip® drives, flash memory cards, universal serial bus (USB) flash drives, secure digital (SD) cards, DVD disks, digital video tape, and the like. Computer-readable storage media 822 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, dynamic random access memory (DRAM)-based SSDs, magnetoresistive RAM (MRAM) SSDs, and hybrid SSDs that use a combination of DRAM and flash memory based SSDs.

In certain aspects, storage subsystem 818 may also include a computer-readable storage media reader 820 that can further be connected to computer-readable storage media 822. Reader 820 may receive and be configured to read data from a memory device such as a disk, a flash drive, etc.

In certain aspects, computer system 800 may support virtualization technologies, including but not limited to virtualization of processing and memory resources. For example, computer system 800 may provide support for executing one or more virtual machines. In certain aspects, computer system 800 may execute a program such as a hypervisor that facilitates the configuring and managing of the virtual machines. Each virtual machine may be allocated memory, compute (e.g., processors, cores), I/O, and networking resources. Each virtual machine generally runs independently of the other virtual machines. A virtual machine typically runs its own operating system, which may be the same as or different from the operating systems executed by other virtual machines executed by computer system 800. Accordingly, multiple operating systems may potentially be run concurrently by computer system 800.

Communications subsystem 824 provides an interface to other computer systems and networks. Communications subsystem 824 serves as an interface for receiving data from and transmitting data to other systems from computer system 800. For example, communications subsystem 824 may enable computer system 800 to establish a communication channel to one or more client devices via the Internet for receiving and sending information from and to the client devices.

Communication subsystem 824 may support both wired and/or wireless communication protocols. For example, in certain aspects, communications subsystem 824 may include radio frequency (RF) transceiver components for accessing wireless voice and/or data networks (e.g., using cellular telephone technology, advanced data network technology, such as 3G, 4G or EDGE (enhanced data rates for global evolution), Wi-Fi (IEEE 802.XX family standards, or other mobile communication technologies, or any combination thereof), global positioning system (GPS) receiver components, and/or other components. In some aspects communications subsystem 824 can provide wired network connectivity (e.g., Ethernet) in addition to or instead of a wireless interface.

Communication subsystem 824 can receive and transmit data in various forms. For example, in some aspects, in addition to other forms, communications subsystem 824 may receive input communications in the form of structured and/or unstructured data feeds 826, event streams 828, event updates 830, and the like. For example, communications subsystem 824 may be configured to receive (or send) data feeds 826 in real-time from users of social media networks and/or other communication services such as Twitter® feeds, Facebook® updates, web feeds such as Rich Site Summary (RSS) feeds, and/or real-time updates from one or more third party information sources.

In certain aspects, communications subsystem 824 may be configured to receive data in the form of continuous data streams, which may include event streams 828 of real-time events and/or event updates 830, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 824 may also be configured to communicate data from computer system 800 to other computer systems or networks. The data may be communicated in various different forms such as structured and/or unstructured data feeds 826, event streams 828, event updates 830, and the like to one or more databases that may be in communication with one or more streaming data source computers coupled to computer system 800.

Computer system 800 can be one of various types, including a handheld portable device (e.g., an iPhone® cellular phone, an iPad® computing tablet, a personal digital assistant (PDA)), a wearable device (e.g., a Meta Quest® head mounted display), a personal computer, a workstation, a mainframe, a kiosk, a server rack, or any other data processing system. Due to the ever-changing nature of computers and networks, the description of computer system 800 depicted in FIG. 8 is intended only as a specific example. Many other configurations having more or fewer components than the system depicted in FIG. 8 are possible. Based on the disclosure and teachings provided herein, a person of ordinary skill in the art can appreciate other ways and/or methods to implement the various aspects.

Although specific aspects have been described, various modifications, alterations, alternative constructions, and equivalents are possible. Embodiments are not restricted to operation within certain specific data processing environments, but are free to operate within a plurality of data processing environments. Additionally, although certain aspects have been described using a particular series of transactions and steps, it should be apparent to those skilled in the art that this is not intended to be limiting. Although some flowcharts describe operations as a sequential process, many of the operations can be performed in parallel or concurrently. In addition, the order of the operations may be rearranged. A process may have additional steps not included in the figure. Various features and aspects of the above-described aspects may be used individually or jointly.

Further, while certain aspects have been described using a particular combination of hardware and software, it should be recognized that other combinations of hardware and software are also possible. Certain aspects may be implemented only in hardware, or only in software, or using combinations thereof. The various processes described herein can be implemented on the same processor or different processors in any combination.

Where devices, systems, components or modules are described as being configured to perform certain operations or functions, such configuration can be accomplished, for example, by designing electronic circuits to perform the operation, by programming programmable electronic circuits (such as microprocessors) to perform the operation such as by executing computer instructions or code, or processors or cores programmed to execute code or instructions stored on a non-transitory memory medium, or any combination thereof. Processes can communicate using a variety of techniques including but not limited to conventional techniques for inter-process communications, and different pairs of processes may use different techniques, or the same pair of processes may use different techniques at different times.

Specific details are given in this disclosure to provide a thorough understanding of the aspects. However, aspects may be practiced without these specific details. For example, well-known circuits, processes, algorithms, structures, and techniques have been shown without unnecessary detail in order to avoid obscuring the aspects. This description provides example aspects only, and is not intended to limit the scope, applicability, or configuration of other aspects. Rather, the preceding description of the aspects can provide those skilled in the art with an enabling description for implementing various aspects. Various changes may be made in the function and arrangement of elements.

The specification and drawings are, accordingly, to be regarded in an illustrative rather than a restrictive sense. It can, however, be evident that additions, subtractions, deletions, and other modifications and changes may be made thereunto without departing from the broader spirit and scope as set forth in the claims. Thus, although specific aspects have been described, these are not intended to be limiting. Various modifications and equivalents are within the scope of the following claims.

What is claimed is:

1. A method comprising:
storing, within a first database, (i) identifiers of a set of active cloud resources within a cloud environment, and (ii) for each active cloud resource within the set of active cloud resources, an identifier of a corresponding tenancy of the cloud environment;
storing, within a second database, (i) identifiers of a set of tenancies within the cloud environment, and (ii) for each tenancy within the set of tenancies, a corresponding tenancy status,
wherein within the second database, each of a first subset of the set of tenancies has a status of being active in the cloud environment, and
wherein within the second database, each of a second subset of the set of tenancies has a status of being terminated from the cloud environment;
querying the first database and the second database to identify a first active cloud resource within a first tenancy, such that the first tenancy has a tenancy status of being terminated from the cloud environment;
tagging the first tenancy with an unaccounted tag; and
responsive at least in part to the first tenancy being tagged with the unaccounted tag, performing one or more of (i) terminating the first tenancy, (ii) terminating one or more active cloud resources within the first tenancy, including terminating the first active cloud resource, or (iii) changing a status of the first tenancy from terminated to active.

2. The method of claim 1, further comprising:
periodically or intermittently querying the first database and the second database, to identify whether any active cloud resource of the first database is within a tenancy having a status of being terminated in the second database.

3. The method of claim 1, wherein the first database and the second database are queried using a multiple joins query that joins data of the first database and the second database.

4. The method of claim 1, wherein the status of the first tenancy is changed from terminated to active, and wherein the method further comprises:
adding the first tenancy to an account database that is used to bill customers of one or more active tenancies of the cloud environment.

5. The method of claim 1, wherein the status of the first tenancy is changed from terminated to active, and wherein the method further comprises:
subsequent to changing the status of the first tenancy from terminated to active, determining that one or more critical information of the first tenancy is missing from one or both the first database and the second database; and
generating a report that the one or more critical information of the first tenancy is missing.

6. The method of claim 5, wherein the one or more critical information of the first tenancy comprises one or more of (i) billing information associated with the first tenancy, and/or (ii) contact information associated with the first tenancy.

7. The method of claim 1, wherein the set of active cloud resources within the cloud environment include one or more of (i) one or more active compute instances, and (ii) one or more active software agents operating within an active compute instance.

8. The method of claim 1, wherein the first database lacks a status of each tenancy, whose identifiers are included within the first database.

9. The method of claim 1, further comprising:
receiving communication from a second active cloud resource;
identifying a second tenancy including the second active cloud resource, responsive at least in part to receiving the communication from the second active cloud resource;
determining a status of the second tenancy;
determining that the status of the second tenancy is terminated;
tagging the second tenancy with the unaccounted tag; and
responsive at least in part to the second tenancy being tagged with the unaccounted tag, performing one or more of (i) terminating the second tenancy, (ii) terminating one or more active cloud resources of the second tenancy, including terminating the second active cloud resource, or (iii) changing a status of the second tenancy from terminated to active.

10. The method of claim 9, wherein the second tenancy including the second active cloud resource is identified from the first database.

11. The method of claim 9, wherein the status of the second tenancy is determined from the second database.

12. A non-transitory computer-readable medium including instructions that when executed by one or more processors, cause the one or more processors to perform operations including:
receiving communication from an active cloud resource of a cloud environment;
identifying a tenancy including the active cloud resource, responsive at least in part to receiving the communication from the active cloud resource;
determining that a status of the tenancy is terminated;
identifying a plurality of active cloud resources within the tenancy, the plurality of active cloud resources including the active cloud resource from which the communication was received;
tagging the tenancy with an unaccounted tag; and
responsive at least in part to the tenancy being tagged with the unaccounted tag, performing one or more of (i) terminating the tenancy, (ii) terminating the plurality of active cloud resources, or (iii) changing a status of the tenancy from terminated to active.

13. The non-transitory computer-readable medium of claim 12, wherein the communication is in the form of a service request, a log message, or data.

14. The non-transitory computer-readable medium of claim 12, the operations include:
storing, within a database, (i) identifiers of a set of active cloud resources within the cloud environment, and (ii) for each active cloud resource within the set of active cloud resources, an identifier of a corresponding tenancy of the cloud environment;
wherein the tenancy including the active cloud resource is identified from the database.

15. The non-transitory computer-readable medium of claim 12, the operations include:
storing, within a database, (i) identifiers of a set of tenancies within the cloud environment, and (ii) for each tenancy within the set of tenancies, a corresponding tenancy status,
wherein the status of the tenancy is determined to be terminated from the database.

16. A system for managing agents in a cloud environment, the system comprising:
one or more processors;
a first storage repository for storing a first database that includes (i) identifiers of a set of active cloud resources within a cloud environment, and (ii) for each active cloud resource within the set of active cloud resources, an identifier of a corresponding tenancy of the cloud environment;
a second storage repository for storing a second database that includes (i) identifiers of a set of tenancies within the cloud environment, and (ii) for each tenancy within the set of tenancies, a corresponding tenancy status,
wherein within the second database, each of a first subset of the set of tenancies has a status of being active in the cloud environment, and
wherein within the second database, each of a second subset of the set of tenancies has a status of being terminated from the cloud environment; and
one or more non-transitory computer-readable media storing instructions, which, when executed by the system, cause the system to perform a set of actions including:
querying the first database and the second database to identify a first active cloud resource within a first tenancy, such that the first tenancy has a tenancy status of being terminated from the cloud environment,
tagging the first tenancy with an unaccounted tag, and
responsive at least in part to the first tenancy being tagged with the unaccounted tag, performing one or more of (i) terminating the first tenancy, (ii) terminating one or more active cloud resources within the first tenancy, including terminating the first active cloud resource, or (iii) changing a status of the first tenancy from terminated to active.

17. The system of claim 16, wherein the set of actions further includes:
periodically or intermittently querying the first database and the second database, to identify whether any active cloud resource of the first database is within a tenancy having a status of being terminated in the second database.

18. The system of claim 16, wherein the first database and the second database are queried using a multiple joins query that joins data of the first database and the second database.

19. The system of claim 16, wherein the status of the first tenancy is changed from terminated to active, and wherein the set of actions further includes:
adding the first tenancy to an account database that is used to bill customers of one or more active tenancies of the cloud environment.

20. The system of claim 16, wherein the set of active cloud resources within the cloud environment include one or more of (i) one or more active compute instances, and (ii) one or more active software agents operating within an active compute instance.
